(19) United States
(12) Patent Application Publication
(10) Pub. No.: US 2021/0324310 A1
(43) Pub. Date: Oct. 21, 2021

(54) AUTOMATED BEER BREWING DEVICE

(71) Applicant: BREWJACKET, INC., Boulder, CO (US)

(72) Inventors: Aaron Walls, Boulder, CO (US); Matthew Goff, Broomfield, CO (US); Evgeniy Tkachenko, Broomfield, CO (US); Chris Collins, Boulder, CO (US)

(73) Assignee: BREWJACKET, INC., Boulder, CO (US)

(21) Appl. No.: 17/272,554

(22) PCT Filed: Aug. 30, 2019
(86) PCT No.: PCT/US19/49160

§ 371 Date: Mar. 1, 2021

Related U.S. Application Data
(60) Provisional application No. 62/725,046, filed on Aug. 30, 2018.

(51) Int. Cl. C12C 13/10; C12C 7/28; C12C 11/00; G05B 19/042

(52) U.S. Cl. CPC C12C 13/10; C12C 7/28; G05B 2219/2645; G05B 19/042; C12C 11/006

(57) ABSTRACT

A device for automatically brewing beer that automates the tasks and operations of the brewing process. The device has an insulated enclosure, a brewing chamber positioned within the enclosure, a flexible brew pouch positioned below and fluidly interconnected to the brewing chamber, wherein the flexible brew pouch can be adjusted between a first volume and at least a second volume that is greater than the first volume, a yeast collection bin positioned below and interconnected to the brew pouch, and at least one source of heat positioned within the enclosure. A temperature sensor is associated with the brewing chamber. A pressure sensor, a near infrared sensor, and a heat exchanger are associated with the brew pouch. A controller operates the heat exchange assembly and the source of heat according to data received from the temperature sensor, the near infrared sensor, and the pressure sensor and a recipe that is uploaded to the controller by a user to automatically brew beer.

### BACKGROUND OF THE INVENTION

### 1. Field of the Invention

The present invention relates to beer brewing and, more specifically, to a device for automating the complicated aspects of the brewing process without boiling.

### 2. Description of the Related Art

The beer brewing process involves soaking grains in hot water to convert the starches present in grains into sugars in a vessel called a mash tun. The resulting sugar water is called wort. Wort is transferred to a boil kettle where it is boiled with hops to impart bitterness. The wort is then cooled down and transferred to a fermenter where yeast is introduced to the now cool wort. The wort is fermented over multiple days or weeks. After fermentation is complete, the wort is called beer. The beer may then be transferred into kegs, bottles, cans, or other serving vessels.

Beer brewing is a complicated and risky process. It requires a deep knowledge to ensure that the equipment is set up properly and used properly. Home brewers must research best practices and identify the correct equipment for their situation that will achieve the best beer possible. The time required to research, learn, and procure equipment is prohibitive for most normal consumers. The brewing process also requires adherence to best practices to ensure the beer does not become infected, does not become oxidized, that the yeast are handled properly, that the equipment is cleaned properly, etc.

Beer brewing is also time consuming. A normal consumer wishing to produce beer will be required to spend up to 12 hours preparing and brewing the beer, more time sanitizing fermenters and bottling or kegging equipment, and multiple weeks managing the temperature of the fermentation to ensure the yeast do not produce off-flavors, some of which can ruin the beer. After fermentation, the consumer is then required to clean all the equipment for the next time they wish to brew.

Beer brewing is also expensive. Commercial beer brewing equipment requires beer to be produced in extremely high volume to offset the cost of production and those costs are passed onto the end consumer. The cost of equipment for commercial breweries ranges from many thousands to many millions of dollars depending on the volume being produced and control required over the processes. Brewing beer at home requires a plethora of equipment ranging from the hundreds to thousands of dollars. Beer brewing also produces a lot of water waste. Some estimates of wastage range from five to fifteen times of water wasted per equal amount of beer produced. This is true both commercially and for home use.

As a result of the difficulties, home brewing is prohibitive for most normal consumers. Accordingly, there is a need in the art for an approach that can make brewing more accessible to ordinary consumers.

### BRIEF SUMMARY OF THE INVENTION

The present invention is a device for automatically brewing beer that can make brewing more accessible to ordinary consumers by automating the more difficult tasks and operations of the brewing process. The device comprises an enclosure having at least one door for permitting access to an interior of the enclosure, a brewing chamber positioned within the enclosure, a flexible brew pouch positioned below and interconnected to the brewing chamber that has an adjustable volume, a yeast collection bin positioned below and interconnected to the flexible brew pouch, and at least one source of heat positioned within the enclosure. A pressure sensor is associated with the brewing chamber. A temperature sensor and a near infrared sensor are associated with the brew pouch. A heat exchange assembly associated with the brew pouch. A controller is interconnected to the temperature sensor, the pressure sensor, the near infrared sensor, the heat exchange assembly, and the at least one source of heat. The controller is programmed to operate the heat exchange assembly and the source of heat according to data received from the temperature sensor, the near infrared sensor, and the pressure sensor. An input/output connection associated with the controller is used to receive a recipe received from a user that programs the controller how to operate the heat exchange assembly and the source of heat and to provide notifications to a user. The capacity of the flexible brew pouch is selectable using a volume restrictor to control how liquid is positioned between the brewing chamber and the flexible brew pouch. The controller may be programmed to drive the heat source so that the wort reaches a temperature sufficient to achieve pasteurization. A first quick connect valve may be used to interconnect the brewing chamber and the brew pouch. A second quick connect valve may be used to interconnect the brew pouch and the yeast collection bin. The input/output connection may comprise a wireless interface for connecting wirelessly to a remotely positioned computing device.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of a device for automatically brewing beer according to the present invention;

FIG. 2 is a schematic of the electronic components for a device for automatically brewing beer according to the present invention;

FIG. 3 is a schematic of the control elements for a device for automatically brewing beer according to the present invention.

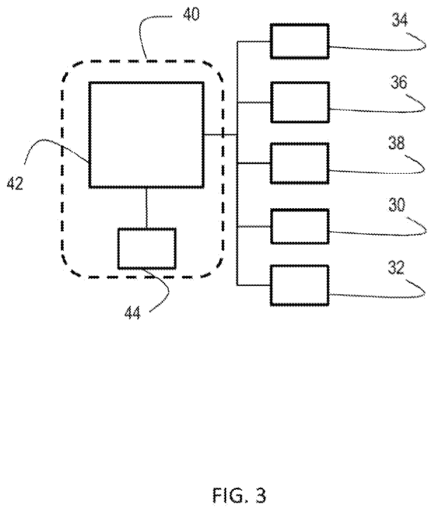

### DETAILED DESCRIPTION OF THE INVENTION

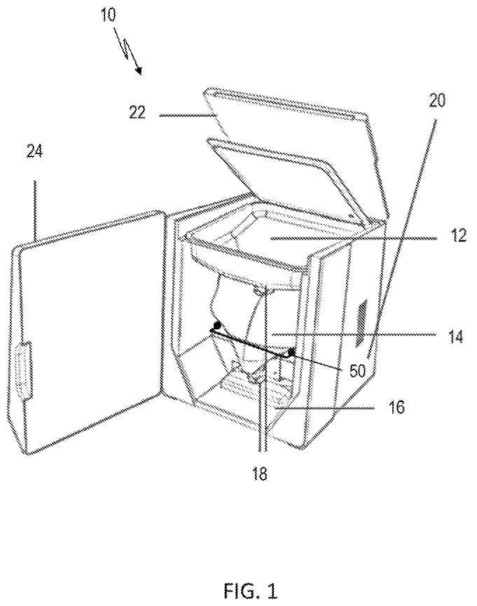

Referring to the figures, wherein like numeral refer to like parts throughout, there is seen in FIG. 1 an automated beer brewing device 10 that can perform all of the critical operations necessary for brewing a quantity of beer and without the need for boiling. Device 10 can create wort without boiling and can ferment the wort according to a computer-controlled recipe. Device 10 can also alter the recipe based on sensor feedback to produce defect-free beer. As seen in FIG. 1, device 10 comprises a brewing chamber 12, a flexible brew pouch 14 positioned below the brewing chamber 12, and a yeast collection bin 16 positioned below the brewing pouch 14. Brewing chamber 12, brewing pouch 14, and yeast collection bin 16 are interconnected together via quick disconnect valves 18 and housed within an insulated enclosure 20 having a top door 22 and a front door 24.

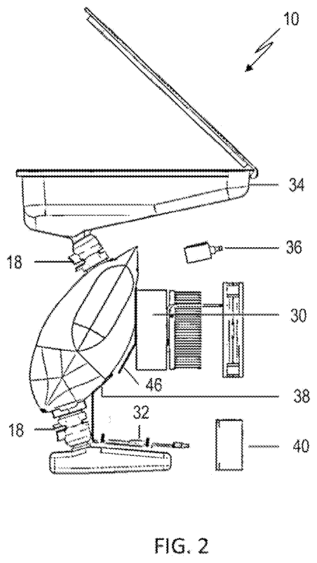

Referring to FIG. 2, device 10 includes a thermoelectric heat exchange assembly 30 positioned proximately to brew pouch 14. Device 10 further includes a heating element 32 positioned within enclosure 20. A pressure sensor 34 is positioned outside of enclosure 20 for monitoring yeast activity. A temperature sensor 36 is associated with brew pouch 14 to monitor brewing temperatures. An infrared sensor 38 is positioned to monitor brew pouch 14. A vibratory motor 46 is associated with brew pouch 14 to assist in clearing waste products out of the brew pouch. A printed circuit board 40 having a controller 42 (including memory/storage capabilities) is interconnected to temperature sensor 34 and pressure sensor 36. Printed circuit board 40 further includes and I/O connection 44 that allow specific brewing instructions corresponding to a particular beer recipe to be communicated to controller 42 from an external device, such as a computer or user input device. Controller 42 is thus also configured to operate thermoelectric heat exchange assembly 30 and heating element 32 using brewing instructions provided by the user and data received from temperature sensor 34 and pressure sensor 36. I/O connection 44 can include any combination of displays, lights, audible devices, as well as network connections to an application on an external computer, phone, tablet, etc. such as USB connection or a wireless connection using a wireless protocol, such as Bluetooth®.

Device 10 may be used to brew beer with a user uploading a particular recipe to controller 42 via I/O connection 44. The user then loads the appropriate amount of water, grains, hops (isomerized and/or non-isomerized), and other brewing ingredients as specific by the recipe into brewing chamber 12. Device 10 allows for the brewing process to begin and proceed with brewing grains, isomerized, and non-isomerized hops present at the same time, which is not conventionally possible with off-the-shelf brewing devices. Brewing chamber 12 does not have different chambers to separate hops from grains, and all items can be loaded at the same time. Device 10 then automatically heats and cools the wort in brewing chamber 12 according to the recipe by controller 42 powering heating element 32 and/or the thermoelectric heat exchange assembly 30. As required by the recipe, the user may be notified by way of I/O connection 44 to a user interface or connected device to remove the brewing ingredients from brewing chamber 12 and to add any additional brewing ingredients, such as dry hops that need cooler temperatures, and yeast into brew chamber 12. Device 10 then monitors yeast activity through the temperature, pressure, and near infrared sensors and adjusts the temperature according to yeast activity level per the recipe being executed. Fermentation status may be reported to the user via I/O connection 44. Throughout fermentation, solids gather in yeast collection bin 16 positioned on the bottom of enclosure 20. Persistent solids are removed from brew pouch 14 with the vibratory motor 45. The yeast plume residue (known as krausen) gathers in the brewing chamber 12 above brew pouch 14. When fermentation is complete, the user is notified by device 10. Brew pouch 14, which now contains the clean, finished beer may be disconnected from device 10 using quick connect valves 18. The brewing solids and krausen are left behind in brewing chamber 12 and yeast collection bin 16 above and below brew pouch, respectively. Brew pouch 14 containing the completed beer may be placed into a dispenser for consumption or aging.

A volume restrictor 50 is positioned in enclosure 20 and moveable between at least two positions, and preferably three positions, where volume restrictor 50 engages and changes the shape of brew pouch 14 such that the volume of flexible brew pouch 14 can be changed between a first volume and at least a second volume that is greater than the first volume (and preferably, at least a third volume that is greater than the second volume). As the volume of brew pouch 14 is changed, the amount of liquid that can be held in brew pouch 14 changes. As a result, volume restrictor 50 can be used to control the positioning of any liquid in device 10 between brewing chamber 12 and brew pouch 14, and combinations thereof. For example, volume restrictor 50 may comprise a bar that extends transversely across enclosure 20 and is moveable upwardly into engagement with the bottom of flexible brew pouch 14 to reduce the effective volume of flexible brew pouch 14 relative to liquids added from the top of flexible brew pouch 14. As a result, liquid in device 10 may be restricted such that it is at least partially contained in brewing chamber 12 when volume restrictor 50 has limited the volume of flexible brew pouch 14, or allowed to flow entirely downward into a larger volume brew pouch 14.

The purpose of the volume restrictor 50 is to more accurately achieve a targeted sugar to water volume ratio. For the grains to convert to sugar, they must be covered by water. If no water is covering the grains, their potential sugar will not end up in the wort. As an example in a device 10 requiring 5 L of water to complete cover the grains with water, brew pouch 14 may have a total capacity of approximately 4.25 L, which is the amount of liquid the user will remove from the system in the form of finished beer. Yeast waste container 16 should hold approximately 0.25 L. The grains will absorb approximately 1 ml of water for every 1 gram by weight. A recipe calling for 1 kg of grain will absorb roughly 1 L of water. Thus, device 10 can be filled with 9.5 L of water, which will yield about 4.25 L as a finished product, producing a considerable amount of beer that the user is unable to consume (waste). By adding a volume restriction bar for flexible brew pouch 14, flexible brew pouch 14 can be temporarily reduced in volume to approximately 1 L, while still allowing the grains to be fully covered with 5 L of water. When brewing is complete and the restriction bar is released, flexible brew pouch 14 will expand back to its full capacity and wort from brewing chamber 12 will flow down into flexible brew pouch 14. This yields minimal beer waste and a maximum ingredient yield for the user. It should be recognized the particular volumes of brewing chamber 12, flexible brew pouch 14, and yeast waste container 16 may be selected depending on the overall volume of beer that a particular device 10 is intended to brew and the adjustable volumes of flexible brew pouch 14 selected accordingly.

Device 10 is able to achieve finished beer without the need to boil. Device 10 can accomplish this by reaching pasteurization temperatures (temperatures from 145° F. to 165° F.) to ensure a safe product. These pasteurization temperatures are also the temperatures at which enzymes in the grain convert starch into sugar. Device 10 utilizes hops that have been isomerized prior to use in the machine (isomerized hops are the main bittering characteristic in beer, and hops are isomerized by heating the hops for a period of time in the presence of a catalyst, like wort, water, or metals. In traditional brewing, hops are boiled with the wort). The combination of sub-boiling temperatures and isomerized hops results in beer that is comparable to beer that had been boiled.

Device 10 may utilize a number of heating elements strategically placed throughout the machine to achieve an even heating gradient. These heating elements can be placed in areas not expressly indicated in FIG. 2, such as against brew pouch 14, around brewing chamber 12, on or in the quick disconnect valves 18, or even in line with tubing if a pump is included in device 10. Although device 10 does not need to be able to achieve boiling temperatures, device 10 could be configured to reach a boil by means of introducing a pump and multiple chambers where non-isomerized hops are loaded as it done with conventional systems to circulate boiling or near-boiling wort through separate hop chambers according to a schedule set forth by the recipe loaded into controller 42.

Device 10 may take up to 24 hours to complete one brewing cycle (heating the wort, converting grain starches to sugars, pasteurizing, and chilling to yeast pitch temperatures (a strain dependent range, usually between 50° F. and 90° F.). Heating could be accelerated up adding higher wattage heating elements and/or a pumping system to circulate the wort throughout the system to maximize surface area contact with the heating elements. Cooling time could be accelerated up by adding more Peltier devices, increasing the thermoelectric wattage, adding a compressor-based cooling system, or including a pump to circulate the wort.

The yeast monitoring system of device 10 utilizes either pressure releases from the CO₂ created by yeast, or near infrared spectroscopy to read absorption of sugar or other solids in suspension, or both, as an indicator of beer completeness. When combined with data generated through real taste tests, device 10 is capable of accurately predicting when a beer is ready to drink. Many variables impact beer completeness, such as time, yeast strain, amount of yeast added to the wort, temperature during fermentation, pressure during fermentation, composition of the wort, nutrient levels, and pH levels. Device 10 is capable of adjusting according to these factors based on user input and real time instructions to the user based on sensor feedback. The result is a beer that ferments faster and with fewer flaws than a beer which was fermented using traditional home brewing methods.

The present invention thus eliminates the complications of beer brewing and removes the risks of oxidation, infection, and other brewing errors. The invention allows a normal consumer to brew commercial quality beer without beer brewing knowledge and skills. The constant and accurate monitoring allows the beer brew to be executed by a recipe controlled by a computer. Utilizing a database of previous brews, device 10 allows the onboard systems to adjust the parameters of the recipe based on sensor feedback in real time. This removes the requirement for the user to have an in-depth beer brewing knowledge. The result is a user friendly machine that a novice can operate with ease and enjoyment.

Utilizing the same vessel to brew, ferment, and serve the beer offers numerous advantages over using separate vessels for each task. For example, the risk of oxidation and infection is minimized as exposure to the external environment is minimized. In addition, there is no need to sanitize the vessel as it first goes through a pasteurization step prior to fermentation and serving. No cleaning of brew pouch 14 is required as it can be disposed after the beer has been consumed.

The automated nature of device 10 allows the user to add ingredients to the machine and then activate the brewing cycle. Device 10 executes the brew automatically and without additional input from the user. This approach allows the consumer to prepare a beer in as few as five minutes time compared to multiple hours or more when brewing manually.

What is claimed is:

1. A device for automatically brewing beer, comprising:
an enclosure having at least one door for permitting access to an interior of the enclosure;
a brewing chamber positioned within the enclosure for receiving a first amount of hops and a first amount of grains without separation;
a flexible brew pouch positioned below and fluidly interconnected to the brewing chamber, wherein the flexible brew pouch can be adjusted between a first volume and at least a second volume that is greater than the first volume;
a yeast collection bin positioned below and fluidly interconnected to the brew pouch; and
at least one source of heat positioned within the enclosure.

2. The device of claim 1, further comprising a temperature sensor associated with the brewing chamber.

3. The device of claim 2, further comprising a pressure sensor and a near infrared sensor associated with the brew pouch.

4. The device of claim 3, further comprising a heat exchange assembly associated with the brew pouch.

5. The device of claim 4, further comprising a controller interconnected to the temperature sensor, the pressure sensor, the near infrared sensor, the heat exchange assembly, and the at least one source of heat.

6. The device of claim 5, wherein the controller is programmed to operate the heat exchange assembly and the source of heat according to data received from the temperature sensor, the near infrared sensor, and the pressure sensor.

7. The device of a claim 6, further comprising an input/output connection associated with the controller.

8. The device of claim 7, wherein the controller is programmed to operate the heat exchange assembly and the source of heat according to a recipe received from a user via the input/output connection.

9. The device of claim 8, wherein the controller is programmed to provide notifications to a user via the input/output connection.

10. The device of claim 9, further comprising a volume restrictor associated with the flexible brew pouch that is moveable relative to the flexible brew pouch to adjust the flexible brew pouch between the first volume and the second volume.

11. The device of claim 10, wherein the controller is programmed to drive the source of heat so that the enclosure reaches a temperature sufficient to achieve pasteurization without boiling.

12. The device of claim 11, further comprising a first quick connect valve interconnecting the brewing chamber and the brew pouch.

13. The device of claim 12, further comprising a second quick connect valve interconnecting the brew pouch and the yeast collection bin.

14. The device of claim 13, wherein the input/output connection comprises a wireless interface for connecting wirelessly to a remotely positioned computing device.
